(19) United States
(12) Patent Application Publication
(10) Pub. No.: US 2018/0175751 A1
(43) Pub. Date: Jun. 21, 2018

(54) CONTROLLER FOR PERMANENT MAGNET SYNCHRONOUS MOTOR, CONTROL METHOD, AND IMAGE FORMING APPARATUS

(71) Applicant: Konica Minolta, Inc., Tokyo (JP)

(72) Inventors: Kazumichi Yoshida, Toyokawa-shi (JP); Katsuhide Sakai, Toyokawa-shi (JP); Tomonobu Tamura, Toyokawa-shi (JP); Hitoshi Asano, Toyokawa-shi (JP); Harumitsu Fujimori, Tokyo (JP)

(73) Assignee: Konica Minolta, Inc., Tokyo (JP)

(21) Appl. No.: 15/839,981

(22) Filed: Dec. 13, 2017

(30) Foreign Application Priority Data
Dec. 19, 2016 (JP) 2016-245086

(51) Int. Cl. H02P 3/02; H02P 3/14; H02P 21/36; G03G 15/00

(52) U.S. Cl. CPC H02P 3/025; G03G 15/6529; H02P 21/36; H02P 3/14

(57) ABSTRACT

A controller for a permanent magnet synchronous motor having a rotor using a permanent magnet is provided. The rotor rotates by a rotating magnetic field caused by a current flowing through an armature. The controller starts a deceleration control of reducing a rotational speed of the rotor when a stop command is inputted in a state where the rotor rotates at a predetermined rotational speed; and performs a fixed excitation control when the rotational speed is reduced to a set speed. The fixed excitation control includes setting a current for causing a magnetic field vector for stopping the rotor at a target position in accordance with an amount of rotation of the rotor since the deceleration control has started and passing the current through the armature.

The entire disclosure of Japanese Patent application No. 2016-245086, filed on Dec. 19, 2016, is incorporated herein by reference in its entirety.

### BACKGROUND

### 1. Technological Field

The present invention relates to a controller for permanent magnet synchronous motor, a control method, and an image forming apparatus.

### 2. Description of the Related Art

Permanent Magnet Synchronous Motors (PMSM) generally have a stator with windings and a rotor using a permanent magnet. In such permanent magnet synchronous motors, an alternating current is applied to the windings to cause a rotating magnetic field, which rotates the rotor synchronously therewith. The use of a vector control in which an alternating current is used as a vector component of a d-q coordinate system enables the rotor to rotate smoothly with a high efficiency.

Recent years have seen the widespread use of sensorless permanent magnet synchronous motors. Such a sensorless permanent magnet synchronous motor has no encoder and no magnetic sensor for detecting a position of magnetic poles. For this reason, in the vector control on such a sensorless permanent magnet synchronous motor, a method is used in which a position of magnetic poles of a rotor and a rotational speed thereof are estimated based on a current or voltage of the windings. However, a control for causing a predetermined magnetic field without estimating a rotational speed of a rotor and a position of magnetic poles is made for the case where the rotational speed is low, for example, where the rotor starts to rotate or stops. This is because the rotational speed and the position of magnetic poles cannot be estimated at a predetermined degree of accuracy.

Control methods for stopping a rotor includes: a short brake control in which the supply of current is cut off and current paths of a drive circuit are short-circuited to obtain energy from a permanent magnet synchronous motor; and a free running control in which the supply of current is cut off only. The vector control can be used to decelerate the rotor to a speed at which the rotational speed cannot be estimated, and after that, the short brake control or the free running control can be made.

However, the use of such control methods to stop a rotor poses a problem that the rotor stops at different positions due to variations in load or inertial force. For this reason, the sensorless permanent magnet synchronous motor cannot be used for application which involves positioning the load at a predetermined stop position when the rotor stops.

As a conventional technology for stopping a rotor of a sensorless permanent magnet synchronous motor at a desired position, there has been proposed a technology described in Japanese Patent No. 5487105 which relates to a control on a linear synchronous motor. According to the technology, a d-axis electrical angle is produced which changes continuously in response to a position command continuously given from an upper controller, and a current passing through armatures is so controlled that a current passes through the d-axis armature and no current passes through the q-axis armature.

The technology described in Japanese Patent No. 5487105 is to drive the linear synchronous motor which has a movable element travelling in a straight line and a stator extending along the entire length of the travel range of the movable element. The technology is provided on the premise that a position command is given continuously to designate the individual positions of the travelling movable element.

This involves, therefore, continuously giving position commands to designate positions of the movable element, which makes the control therefor complex.

Where a rotor of a permanent magnet synchronous motor is stopped, the stop position thereof is preferably settable minutely. More options for setting the stop positions are better. To be specific, more positions such as 360 positions in increments of 1 degree is better than less positions such as 6 positions in increments of 60 degrees. Stepless options are further better.

In Particular, for positioning the load when the rotor stops, positioning with high accuracy is sought to prevent the rotor from stopping before the magnetic poles reach a desired position and from stopping after the magnetic poles pass the desired position.

### SUMMARY

The present invention has been achieved in light of such a problem, and therefore, an object of an embodiment of the present invention is to provide a controller and control method which step a rotor of a permanent magnet synchronous motor at a desired position.

To achieve at least one of the abovementioned objects, according to an aspect of the present invention, a controller reflecting one aspect of the present invention is a controller for a permanent magnet synchronous motor having a rotor using a permanent magnet, the rotor rotating by a rotating magnetic field caused by a current flowing through an armature, the controller including a drive portion configured to pass a current through the armature to drive the rotor; a speed estimating portion configured to estimate a rotational speed of the rotor based on the current flowing through the armature; a control unit configured to control the drive portion to cause the rotating magnetic field based on an estimated speed that is the rotational speed estimated by the speed estimating portion, to perform, in response to a stop command inputted, a deceleration control of reducing the rotational speed to a switch speed on the drive portion, and then, to perform a fixed excitation control of causing a magnetic field vector for stopping the rotor at a target position on the drive portion; an amount of rotation calculation portion configured to calculate a pre-stop amount of rotation that is an amount of rotation of the rotor since the deceleration control has started; and a fixed excitation setting portion configured to set, in accordance with the pre-stop amount of rotation, the current to be passed through the armature to generate the magnetic field vector.

To achieve at least one of the abovementioned objects, according to another aspect of the present invention, a control method reflecting another aspect of the present invention is a method for controlling a permanent magnet synchronous motor having a rotor using a permanent magnet, the rotor rotating by a rotating magnetic field caused by a current flowing through an armature, the method including starting a deceleration control of reducing a rotational speed of the rotor when a stop command is inputted in a state where the rotor rotates at a predetermined rotational speed; and performing a fixed excitation control when the rotational speed is reduced to a set speed, the fixed excitation control including setting a current for causing a magnetic field vector for stopping the rotor at a target position in accordance with an amount of rotation of the rotor since the deceleration control has started and passing the current through the armature.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram showing an outline of the structure of an image forming apparatus having a motor controller according to an embodiment of the present invention.

FIG. 2 is a diagram schematically showing an example of the structure of a brushless motor.

FIG. 3 is a diagram showing an example of a drive sequence at the time of stop.

FIG. 4 is a diagram showing an example of a d-q axis model of a brushless motor.

FIG. 5 is a diagram showing an example of the functional configuration of a motor controller.

FIG. 6 is a diagram showing an example of the configuration of a motor drive portion and a current detector.

FIGS. 7A and 7B are diagrams showing at example of a magnetic field vector for stopping a rotor and a current vector, respectively.

FIG. 8 is a diagram showing an example of positioning of a load.

FIGS. 9A-9C are diagrams showing examples as to how to set an advance angle.

FIGS. 10A-10C are diagrams showing a first example as to how to set an advance angle depending on a transition of a rotational speed.

FIGS. 11A-11C are diagrams showing a second example as to how to set an advance angle depending on a transition of a rotational speed.

FIGS. 12A-12C are diagrams showing a third example as to how to set an advance angle depending on a transition of a rotational speed.

FIGS. 13A-13C are diagrams showing a fourth example as to how to set an advance angle depending on a transition of a rotational speed.

FIG. 14 is a diagram depicting a first example of the flow of processing in a motor controller.

FIG. 15 is a diagram depicting a second example of the flow of processing in a motor controller.

FIG. 16 is a diagram depicting an example of the flow of processing of a fixed excitation control.

### DETAILED DESCRIPTION OF THE EMBODIMENTS

Hereinafter, one or more embodiments of the present invention will be described with reference to the drawings. However, the scope of the invention is not limited to the disclosed embodiments.

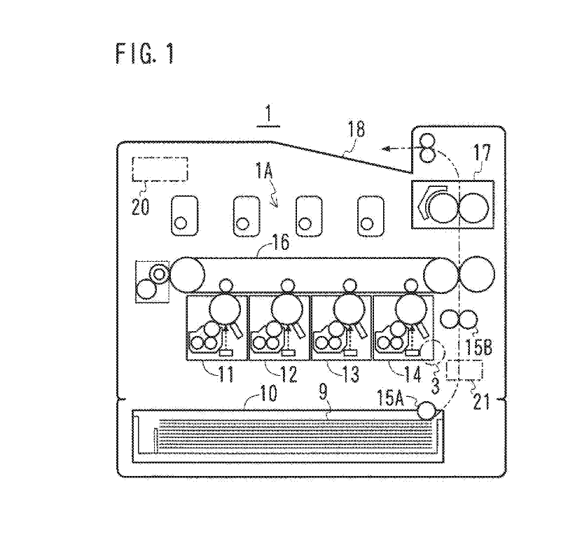

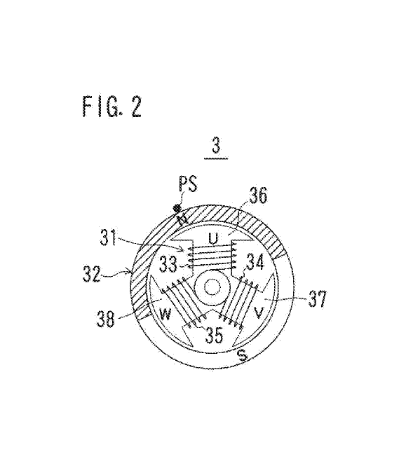

FIG. 1 shows an outline of the structure of an image forming apparatus 1 having a motor controller 21 according to an embodiment of the present invention. FIG. 2 schematically shows an example of the structure of a brushless motor 3.

Referring to FIG. 1, the image forming apparatus 1 is a color printer provided with an electrophotographic printer engine 1A. The printer engine 1A has four imaging stations 11, 12, 13, 14 to form, in parallel, a toner image of four colors of yellow (Y), magenta (M), cyan (C), and black (K). Each of the imaging stations 11, 12, 13, and 14 has a tubular photoconductor, an electrostatic charger, a developing unit, a cleaner, a light source for exposure, and so on.

The toner image of four colors is primarily transferred to the intermediate transfer belt 16, and then secondarily transferred onto paper 9 which has been sent out from a paper cassette 10 by a paper feed roller 15A, has passed through a registration roller pair 15B, and has been conveyed. After the secondary transfer, the paper 9 passes through a fixing unit 17 and then to be delivered to a paper output tray 18 which is provided in an upper part of the image forming apparatus 1. While the paper 9 passes through the fixing unit 17, the toner image is fixed onto the paper 9 by application of heat and pressure.

The image forming apparatus 1 uses a plurality of brushless motors including the brushless motor 3 as drive sources to rotate rotating members such as the fixing unit 17, the intermediate transfer belt 16, the paper feed roller 15A, the registration roller pair 15B, the photoconductor, and a roller for the developing unit. Stated differently, the printer engine 1A uses the rotating members of which rotation is driven by the brushless motors to feed the paper 9 and to form an image onto the paper 9.

The brushless motor 3 is disposed, for example, in the vicinity of the imaging station 14 to drive the rotation of the registration roller pair 15B. The brushless motor 3 is controlled by the motor controller 21.

The motor controller 21 is given a command to begin (start) or stop the rotation by an upper control unit 20. The upper control unit 20 is a controller to control an overall operation of the image forming apparatus 1. The upper control unit 20 gives a command when: the image forming apparatus 1 warms up; the image forming apparatus 1 executes a print job; the image forming apparatus 1 turns into a power saving mode; and so on.

Referring to FIG. 2, the brushless motor 3 is a sensorless Permanent Magnet Synchronous Motor (PMSM). The brushless motor 3 has a stator 31 functioning as an armature for causing a rotating magnetic field and a rotor 32 using a permanent magnet. The stator 31 has a U-phase core 36, a V-phase core 37, and a W-phase core 38 that are located at electrical angle of 120° intervals from one another and three windings (coils) 33, 34, and 35 that are provided in the form of Y-connection. A 3-phase alternating current of U-phase, V-phase, and W-phase is applied to the windings 33-35 to excite the cores 36, 37, and 38 in turn, so that a rotating magnetic field is caused. The rotor 32 rotates in synchronism with the rotating magnetic field.

FIG. 2 shows an example in which the number of magnetic poles of the rotor 32 is two. However, the number of magnetic poles of the rotor 32 is not limited to two, may be four, six, or more than six. The rotor 32 may be an inner rotor or an outer rotor. The number of slots of the stator 31 is not limited to three. In any case, the motor controller 21 performs, on the brushless motor 3, a vector control (sensorless vector control) for estimating a rotational speed and a position of magnetic poles by using a control model based on a d-q axis coordinate system.

It is noted that, in the following description, of an S-pole and an N-pole of the rotor 32, a rotational angular position of the N-pole shown by a filled circle is sometimes referred to as a “position of magnetic pole PS” of the rotor 32.

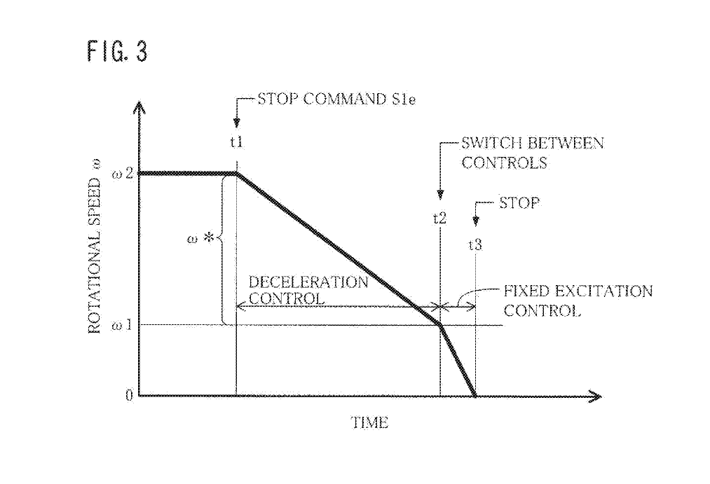

FIG. 3 shows an example of a drive sequence at the time of stop.

When receiving a stop command S1e from the upper control unit 20 at a time t1, the motor controller 21 performs a deceleration control to reduce the rotational speed ω from a speed ω2 of that point in time at a prescribed acceleration (deceleration), for example, at a constant acceleration (deceleration). At a time t2 at which the rotational speed ω is reduced to a switch speed ω1, the motor controller 21 switches the control from the deceleration control to a fixed excitation control to stop the rotor 32 at a desired target position at a time t3.

The deceleration control is a vector control for approximating the rotational speed ω to a target speed (speed command value) ω*. In the deceleration control, the target speed ω* is reduced every moment. For example, the upper control unit 20 updates the target speed every moment so as to reduce the target speed ω* at a ratio determined as an operation pattern, and informs the motor controller 21 of the target speed. Instead of this, the motor controller 21 may generate a target speed ω* for deceleration in accordance with the operation pattern.

The switch speed ω1 which is the final target speed ω* in the deceleration control is so selected to be a lower limit speed at which estimating the position of magnetic pole PS is possible, or, to be a speed slightly higher than the lower limit speed.

The fixed excitation control is a control for passing, through the windings 33-35 of the armature, a current for causing a magnetic field vector which draws the rotor 32 to the target position. The phase and magnitude of the current is set depending on an estimated value of the position of magnetic pole PS at the time t2 at which the deceleration control is finished. The current thus set continues to be passed, so that an unrotating magnetic field (fixed magnetic field) is made act on the rotor 32. The fixed excitation control is detailed later.

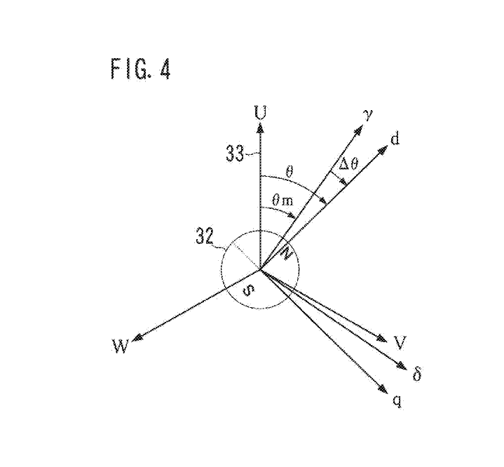

FIG. 4 shows an example of a d-q axis model of the brushless motor 3. The vector control on the brushless motor 3 is simplified by converting the 3-phase alternating current flowing through the windings 33-35 of the brushless motor 3 to a direct current fed to a 2-phase winding which rotates in synchronism with a permanent magnet acting as the rotor 32.

Let the direction of magnetic flux (direction of the N-pole) of the permanent magnet be a d-axis (reactive current axis). Let the direction of movement from the d-axis by an electrical angle of π/2[rad] (90°) be a q-axis (active current axis). The d-axis and the q-axis are model axes. The U-Phase winding 33 is used as a reference and a movement angle of the d-axis with respect to the reference is defined as an angle θ. The angle θ represents an angular position of a magnetic pole (position of magnetic pole PS) with respect to the U-phase winding 33. The d-q coordinate system is at a position moved, by angle θ, from the reference, namely, the U-phase winding 33.

Since the brushless motor 3 is provided with no position sensor to detect an angular position (position of magnetic pole) of the rotor 32, the motor controller 21 needs to estimate a position of magnetic pole PS of the rotor 32. A γ-axis is defined corresponding to an estimated angle θm which represents the estimated position of the magnetic pole. A δ-axis is defined as a position moved, by an electrical angle of π/2, from the γ-axis. The γ-δ coordinate system is positioned moved, by estimated angle θm, from the reference, namely, the U-phase winding 33. A delay of the estimated angle θm with respect to the angle θ is defined as an angle Δθ. When the amount of delay Δθ is 0 (zero), the γ-δ coordinate system coincides with the d-q coordinate system.

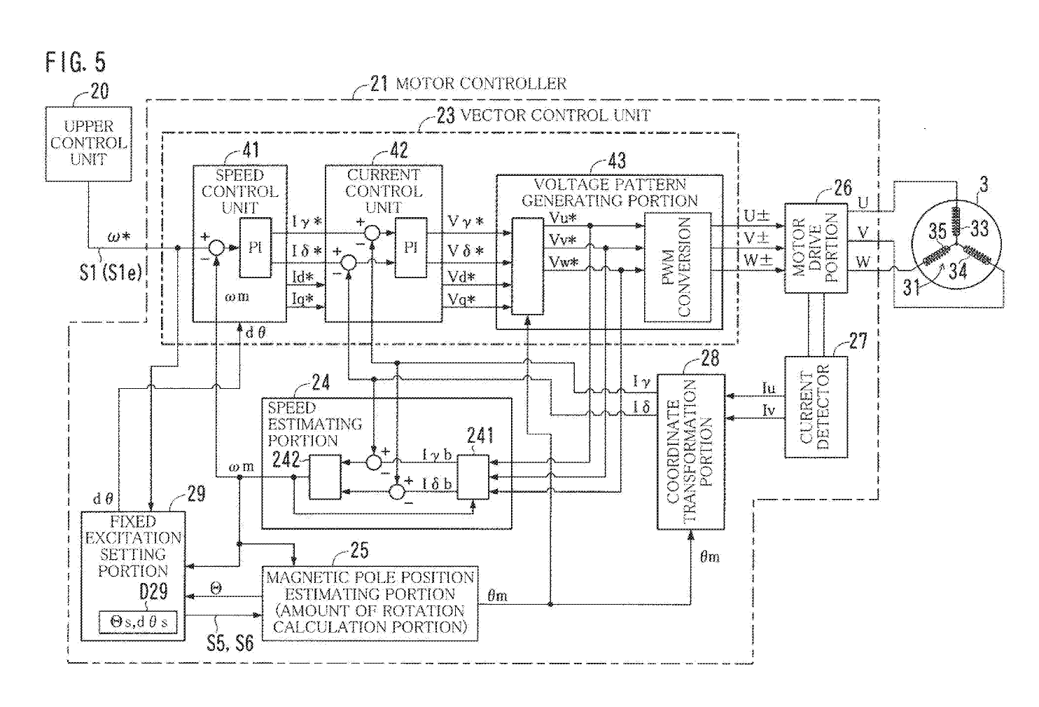

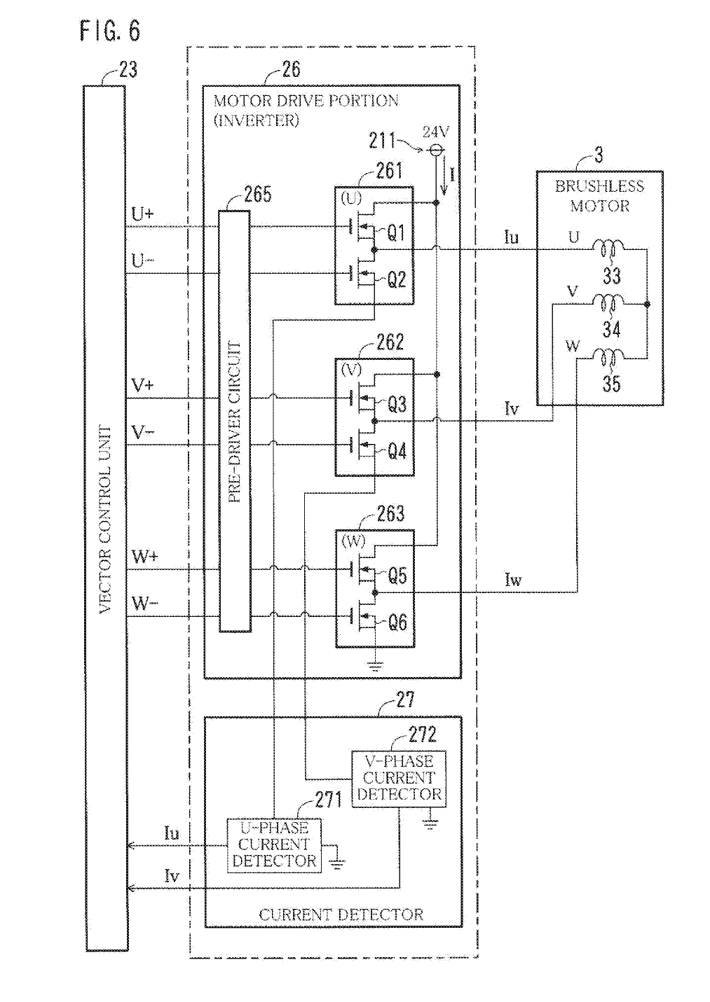

FIG. 5 shows an example of the functional configuration of the motor controller 22. FIG. 6 shows an example of the configuration of a motor drive portion 26 and a current detector 27 of the motor controller 21.

Referring to FIG. 5, the motor controller 21 includes a vector control unit 23, a speed estimating portion 24, a magnetic pole position estimating portion 25, the motor drive portion 26, the current detector 27, a coordinate transformation portion 28, and a fixed excitation setting portion 29.

The motor drive portion 26 is an inverter circuit for supplying a current to the windings 33-35 of the brushless motor 3 to drive the rotor 32. Referring to FIG. 6, the motor drive portion 26 includes three dual elements 261, 262, and 263, and a pre-driver circuit 265.

Each of the dual elements 261-263 is a circuit component that packages therein two transistors having common characteristics (Field Effect Transistor: FET, for example) connected in series.

The dual elements 261-263 control a current I flowing from a DC power line 211 through the windings 33-35 to a ground line. To be specific, transistors Q1 and Q2 of the dual element 261 control a current Iu flowing through the winding 33. Transistors Q3 and Q4 of the dual element 262 control a current Iv flowing through the, winding 34. Transistors Q5 and Q6 of the dual element 263 control a current Iw flowing through the winding 35.

Referring to FIG. 6, the pre-driver circuit 265 converts control signals U+, U−, V+, V−, W+, and W− fed from the vector control unit 23 to voltage levels suitable for the transistors Q1-Q6. The control signals U+, U−, V+, V−, W+, and W− that have been subjected to the conversion are given to control terminals (gates) of the transistors Q1-Q6.

The current detector 27 includes a U-phase current detector 271 and a V-phase current detector 272 to detect currents Iu and Iv flowing through the windings 33 and 34, respectively. Since the relationship of Iu+Iv+Iw=0 is satisfied, the current Iw can be obtained from the calculation of the values of the currents Iu and Iv detected. The current detector 27 may include a W-phase current detector.

The U-phase current detector 271 and the V-phase current detector 272 amplify a voltage drop by a shunt resistor provided in the current path of the currents Iu and Iv to perform A/D conversion on the resultant, and output the resultant as detection values of the currents Iu and Iv. In short, the U-phase current detector 271 and the V-phase current detector 272 make a two-shunt detection. The shunt resistor has a small resistance value of 1/10 Ω order.

The motor controller 21 may be configured by using a circuit component in which the motor drive portion 26 and the current detector 27 are integral with each other.

Referring back to FIG. 5, the vector control unit 23 is given a speed command S1 indicating a target speed (speed command value) ω* by the upper control unit 20. Of the speed Command S1, a command containing information on a stop order is the stop command S1e.

The vector control unit 23 controls, based on an estimated speed ωm inputted by the speed estimating portion 24 and the estimated angle θm inputted by the magnetic pole position estimating portion 25, the motor drive portion 26 to generate a rotating magnetic field which rotates at the target speed ω*. The estimated angle θm is an example of an estimated value of the rotational speed ω of the rotor 32. The estimated angle θm is an example of an estimated value of the position of magnetic pole PS.

The vector control unit 23 includes a speed control unit 41, a current control unit 42, and a voltage pattern generating portion 43. In particular, the speed control unit 41 is heavily involved with the fixed excitation control together with the magnetic pole position estimating portion 25 and the fixed excitation setting portion 29.

The speed control unit 41 performs operation for a Proportional-Integral control (PI control) of making the difference between the target speed ω* given by the upper control unit 20 and the estimated speed ωm given by the speed estimating portion 24 close to 0 (zero) to determine current command values Iγ* and Iδ* of the γ-δ coordinate system. The estimated speed ωm is inputted periodically. Every time the estimated speed ωm is inputted, the speed control unit 41 determines the current command values Iγ* and Iδ* depending on the target speed ω* at that time.

The current control unit 42 performs operation for a proportional-integral control of making the difference between the current command values Iγ* and Iδ* and the estimated current values Iγ and Iδ* sent from the coordinate transformation portion 28 to 0 (zero) to determine voltage command values Vγ* and Vδ* in the γ-δ coordinate system.

The voltage pattern generating portion 43 converts the voltage command values Vγ* and Vδ* to a U-phase voltage command value Vu*, a V-phase voltage command value Vv*, and a W-phase voltage command value Vw* based on the estimated angle θm inputted from the magnetic pole position estimating portion 25. The voltage pattern generating portion 43 then generates patterns of control signals U+, U−, V+, V−, W+, and W− based on the voltage command values Vu*, Vv*, and Vw*, then outputs the same to the motor drive portion 26.

The speed estimating portion 24 includes a first operation portion 241 and a second operation portion 242. The speed estimating portion 24 estimates a rotational speed of the rotor 32 based on the currents Iu, Iv, and Iw flowing through the windings 33-35 of the rotor 32.

The first operation portion 241 calculates current values Iγb and Iδb in the γ-δ coordinate system based on the voltage command Values Vu*, Vv*, and Vw* determined by the voltage pattern generating portion 43. As a modification thereof, the first operation portion 241 may calculate the current values Iγb and Iδb based on the voltage command values Vγ* and Vδ* determined by the current control unit 42. In either case, the first operation portion 241 uses the estimated speed ωm obtained in the previous estimation by the second operation portion 242 to calculate the current command values Iγb and Iδb.

The second operation portion 242 determines an estimated speed (estimated speed value) of ωm in accordance with a so-called voltage current equation based on the difference between estimated current values Iγ and Iδ sent from the coordinate transformation portion 28 and the current values Iγb and Iδb by the first operation portion 241. The estimated speed ωm is given to the speed control unit 41, the magnetic pole position estimating portion 25, and the fixed excitation setting portion 29.

The magnetic pole position estimating portion 25 estimates a position of magnetic pole PS of the rotor 32 based on the estimated speed ωm. To be specific, the estimated speed ωm is integrated to calculate the estimated angle θm.

The magnetic pole position estimating portion 25 also calculates a pre-stop amount of rotation θ which is an amount of rotation of the rotor 32 since the start of the deceleration control in response to the stop command S1e inputted. In short, after the start of the deceleration control, the magnetic pole position estimating portion 25 performs the processing as the amount of rotation calculation portion in parallel with the processing for outputting the estimated angle θm. At the start of the deceleration control, the magnetic pole position estimating portion 25 is fed with a calculation command S5 for giving a command to start calculation of the pre-stop amount of rotation Θ, for example, by the fixed excitation setting portion 29.

The magnetic pole position estimating portion 25 operating as the amount of rotation calculation portion adds up the estimated angles θm as the processing for calculating the pre-stop amount of rotation Θ. The magnetic pole position estimating portion 25 then informs the fixed excitation control portion 29 of the latest pre-stop amount of rotation θ sequentially. The latest pre-stop amount of rotation Θ is preferably a latest pre-stop amount of rotation substantially.

In response to a fixed output command S6 inputted, the magnetic pole position estimating portion 25 stores the estimated angle θm of that time and outputs the estimated angle θm thus stored to the coordinate transformation portion 28 and the voltage pattern generating portion 43 over a period of time of the further fixed excitation control. In short, the output value of the estimated angle θm is made fixed.

The fixed excitation setting portion 29 sets a current to be passed through the armature in the fixed excitation control depending on the pre-stop amount of rotation Θ given by the magnetic pole position estimating portion 25. The detailed description thereof is as follows.

In response to the stop command S1e inputted from the upper control unit 20, the fixed excitation setting portion 29 issues the calculation command S5 to the magnetic pole position estimating portion 25 to cause the same to start the calculation of the pre-stop amount of rotation Θ. Thereafter, when the control is switched from the deceleration control to the fixed excitation control, the fixed excitation setting portion 29 sets an advance angle dθ depending on the latest pre-stop amount of rotation Θ informed by the magnetic pole position estimating portion 25. The advance angle dθ is a control value for designating the phase of a current to the speed control unit 41.

The fixed excitation setting portion 29 stores, therein, control information D29 including a target amount of rotation Θs and a reference advance angle dθs. The target amount of rotation Θs is an amount of rotation corresponding to a target position at which the rotor 32 is to be stopped. The reference advance angle dθs is a set value of the advance angle dθ for the case where there is no difference between the target amount of rotation Θs and the pre-stop amount of rotation Θ.

For setting the advance angle dθ, the fixed excitation setting portion 29 determines a difference between the pre-stop amount of rotation Θ and the target amount of rotation Θs. If the difference determined is larger than the reference advance angle dθs, then the fixed excitation setting portion 29 sets the advance angle dθ to be smaller than the reference advance angle dθs. If the difference is smaller than the reference advance angle dθs, then the fixed excitation setting portion 29 sets the advance angle dθ to be larger than the reference advance angle dθs.

Hereinafter, the operation of the motor controller 21 in further detailed, focusing on the functions involved with the fixed excitation control.

It is to be noted that, in the fixed excitation control, an axis determined based on the estimated angle θm, namely, a so-called γ-axis, is handled as the d-axis for the sake of convenience, and similarly, the δ-axis is handled as the q-axis.

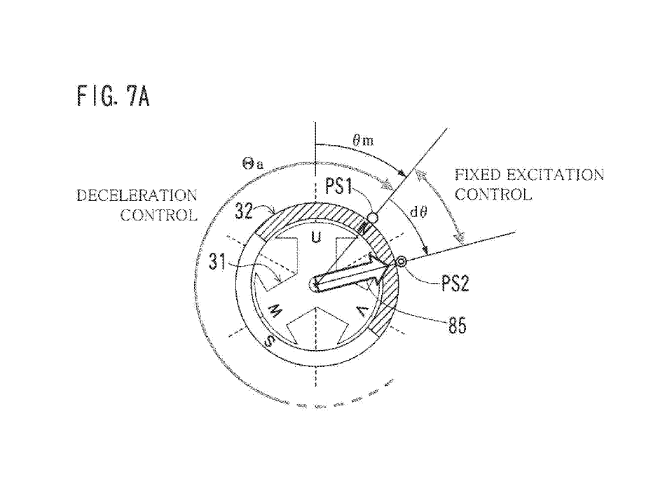

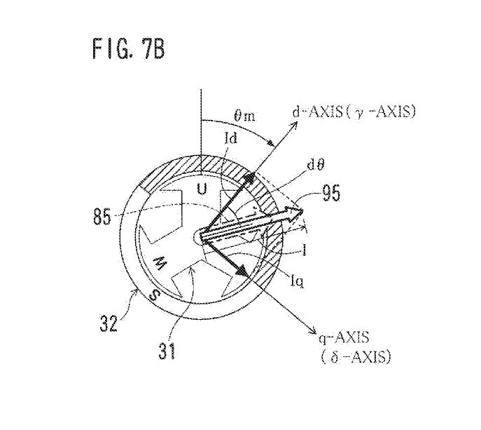

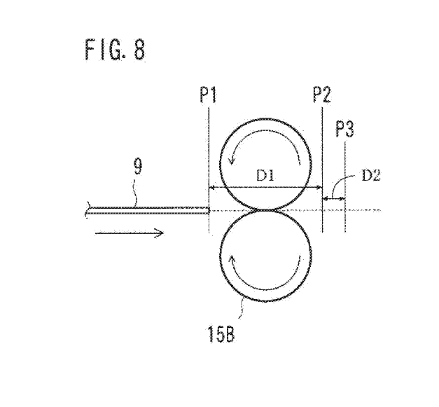

FIGS. 7A and 7B show an example of a magnetic field vector 85 for stopping the rotor 32 and a current vector 95, respectively. FIG. 8 shows an example of positioning of a load. In FIG. 7A, a position (intended position) at which the rotor 32 is to be stopped, namely, a target position PS2, is shown by a double circle, and a position of magnetic pole PS at the time of the switch from the deceleration control to the fixed excitation control, namely, a draw-in start position PS1, is denoted by a circle.

Referring also to FIG. 3, in the deceleration control from the time t1 to the time t2, the rotor 32 rotates by an amount of rotation which depends on a length of a period of the deceleration control and the deceleration. Referring to FIG. 7A, the draw-in start position PS1 is the position of magnetic pole PS at the time t2, and is identified by the estimated angle θm.

The target position PS2 is a position to which the rotor 32 rotates, by the advance angle dθ, from the draw-in start position PS1. Stated differently, the control in which the rotor 32 is rotated, by the advance angle dθ, and is caused to be stopped at the target position PS2 is the fixed excitation control.

The target Position PS2 is a rotational angular position with which to position the paper 9 at a position P3 as shown in FIG. 8, for example.

Referring to FIG. 8, in a state where the registration roller pair 15B rotates at a constant speed in accordance with a conveyance speed of the paper 9, the paper 9 is carried toward the registration roller pair 15B. When the leading end of the paper 9 reaches, for example, a position P1 upstream of the registration roller pair 15B, the upper control unit 20 detects the reach to give the stop command S1e to the motor controller 21, so that the deceleration control on the brushless motor 3 starts immediately. It is herein supposed that the acceleration (deceleration) in the deceleration control is constant.

At a time when the leading end of the paper 9 reaches a position P2 downstream of the position P1, the control is switched from the deceleration control to the fixed excitation control. The fixed excitation control is performed, so that the leading end of the paper 9 reaches a position P3 downstream of the position P2 and then the paper 9 stops.

A distance D1 between the position P1 and the position P2, 50 mm, for example, is determined depending on the rotational speed ω of the rotor 32 at the start time point of the deceleration control, a deceleration ratio of a gear which conveys a rotation driving force to the registration roller pair 15B, the deceleration in the deceleration control, and the switch speed ω1. Stated differently, the position P2 is determined depending on the conditions of the deceleration control in the drive sequence (operation pattern). A distance D2 between the position P2 and the position P3, 10 mm, for example, is proportional to the advance angle dθ.

Thus, in order to position the leading end of the paper 9 at the position P3, it is preferable to set the target position PS2 in such a manner that the amount of rotation of the rotor 32 between the issuance of the stop command S1e and the stop of the rotor 32 corresponds to the distance (D1+D2) between the position P1 and the position P3. The target position PS2 is determined depending on the position of magnetic pole PS at a time when the stop command S1e is issued.

Referring back to FIGS. 7A and 7B, in the fixed excitation control, the magnetic field vector 85 stretching from the center of the rotation of the rotor 32 to the target position PS2 is set. The magnetic field vector 85 represents a magnetic field which draws the rotor 32 to the target position PS2.

Setting the magnetic field vector 85 corresponds to setting the current vector 95 of which a direction is the same as that of the magnetic field vector 85 as shown in FIG. 7B. The current vector 95 represents the phase and magnitude of a current to be passed through the windings 33-35 in order to generate a magnetic field which draws the rotor 32 to the target position PS2.

Setting the current vector 95 is to, in practical processing to control the motor drive portion 26, set the direction and magnitude of the current vector 95. As the direction of the current vector 95, the advance angle dθ representing an angle with respect to the d-axis is set. As the magnitude of the current vector 95, a maximum value of a current which can be passed through the brushless motor 3 is set. Thereby, a d-axis component Id and a q-axis component Iq of the current vector 95 are determined.

Supposing that the magnitude of the current vector 95 is denoted by “I”, the d-axis component Id and the q-axis component Iq are expressed with the following equations.

Id=I×cos (dθ)

Id=I×sin (dθ)

The determination of the d-axis component Id and the q-axis component Iq leads to the determination of patterns of the control signals U+, U', V+, V−, W+, and W− by the vector control unit 23 by using the estimated angle θm of an angular position in the d-axis. Then, the magnitude and direction of each of the currents Iu, Iv, and Iw flowing through the motor drive portion 26 is determined.

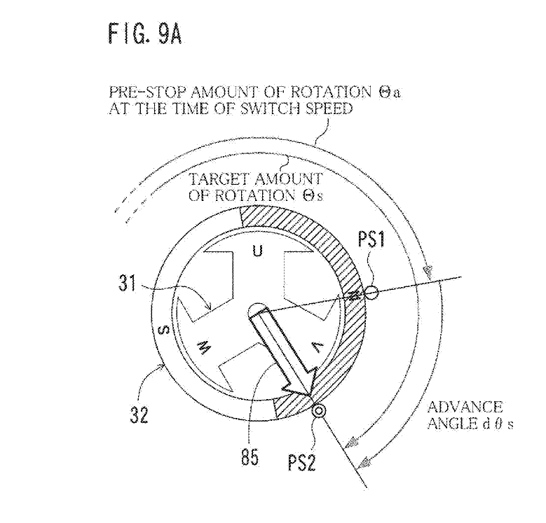

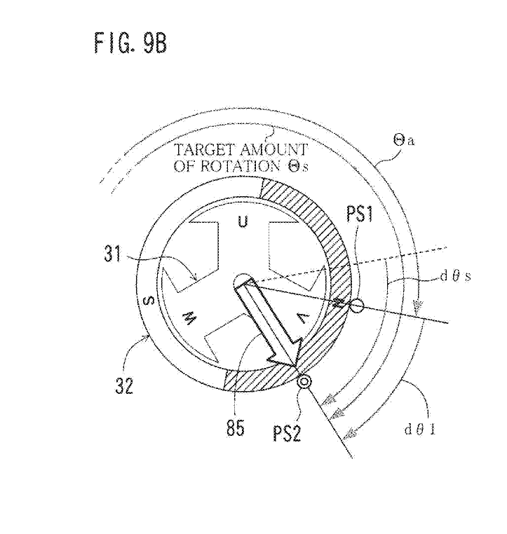

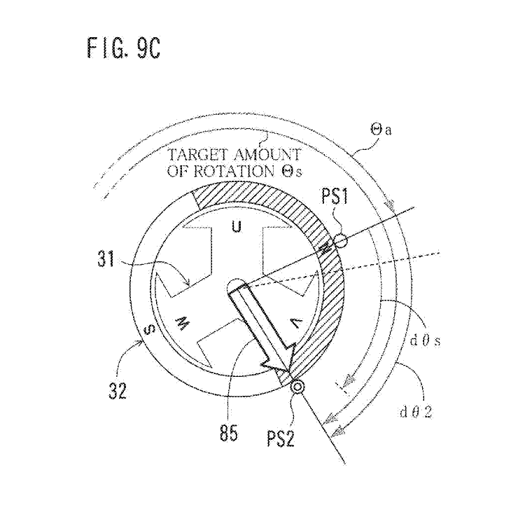

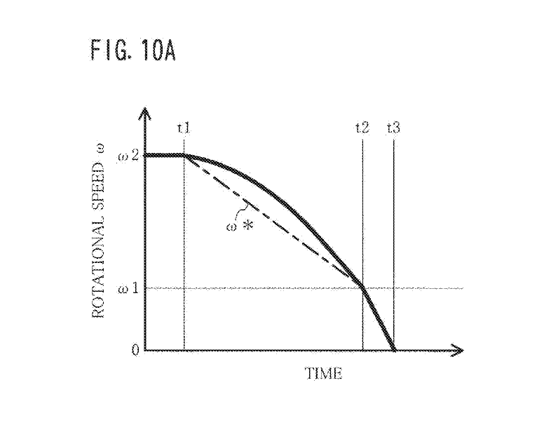

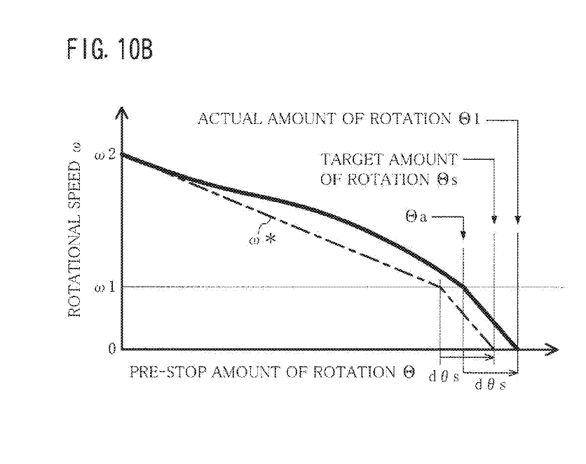

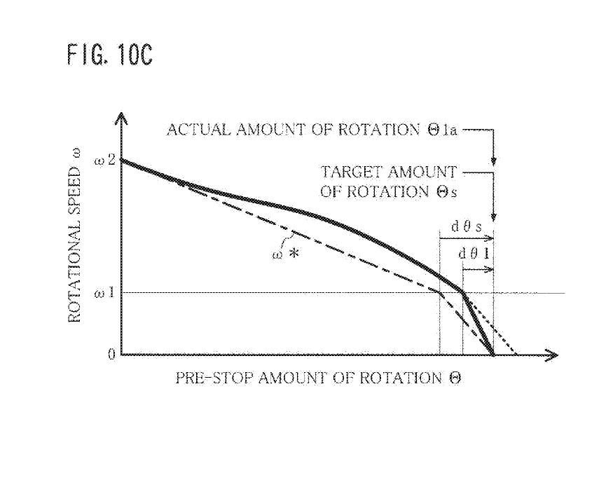

FIGS. 9A-9C show examples as to how to set the advance angle dθ. FIGS. 10A-10C, FIGS. 11A-11C, FIGS. 12A-12C, and FIGS. 13A-13C show a first example, a second example, a third example, and a fourth example as to how to set the advance angle dθ depending on a transition of the rotational speed ω, respectively.

Where the rotational speed ω is reduced along with the change in the target speed ω* without deviating therefrom, the draw-in start position PS1 is a proper position as shown in FIG. 9A. The proper position is a position at which a difference between the target amount of rotation Θs and the pre-stop amount of rotation Θa corresponding to the draw-in start position PS1 is equal to the reference advance angle dθs. In such a case, the fixed excitation setting portion 29 sets the reference advance angle dθs as the advance angle dθ.

In the meantime, as shown in FIGS. 10A-13C, the change in the rotational speed ω shown by the thick line is sometimes deviated from the change in the target speed ω* shown by the chain line in the drawings. The cause thereof is a variation in load, for example. To be specific, the acceleration (ratio of deceleration) is higher at the time of deceleration than at the time of constant speed, a motor torque Ta represented with the following equation is largely subjected to the influence of variation of load inertia and is easy to be greater than a tolerance.

Ta=JL(ωj−ωi)/Δt+TL

wherein JL represents the load inertia, (ωj−ωi)/Δt represents the acceleration, and TL represent a sliding resistance.

Referring to FIG. 10A, the rotational speed ω at the time t2 is reduced to the switch speed ω1, which makes no difference between the switch speed ω1 and the target speed ω*. In the process of the deceleration control, the rotational speed ω is higher than the target speed ω*.

For this reason, as shown in FIG. 10B, the pre-stop amount of rotation Θa at the time (t2) at which the rotational speed ω reaches the switch speed ω1 is larger than the proper amount. Stated differently, as shown in FIG. 9B, the draw-in start position PS1 is closer to the target position PS2 than to the proper position.

In such a case, if the advance angle dθ is set at the reference advance angle dθs, an actual amount of rotation Θ1 which is the pre-stop amount of rotation Θ before the rotor 32 stops becomes larger than the target amount of rotation Θs. Stated differently, the rotor 32 passes the target position PS2 and then stops.

To cope with this, as clear from FIGS. 9B and 10C, the fixed excitation setting portion 29 sets, the advance angle dθ, an advance angle dθ1 which is smaller than the reference advance angle dθS so that the actual amount of rotation Θ1a becomes equal to the target amount of rotation Θ. For example, where the paper 9 travels excessively, by 5 mm, from the position P3 in the positioning shown in FIG. 8, the fixed excitation setting portion 29 sets the advance angle dθ1 so that the conveyance distance is shortened by 5 mm.

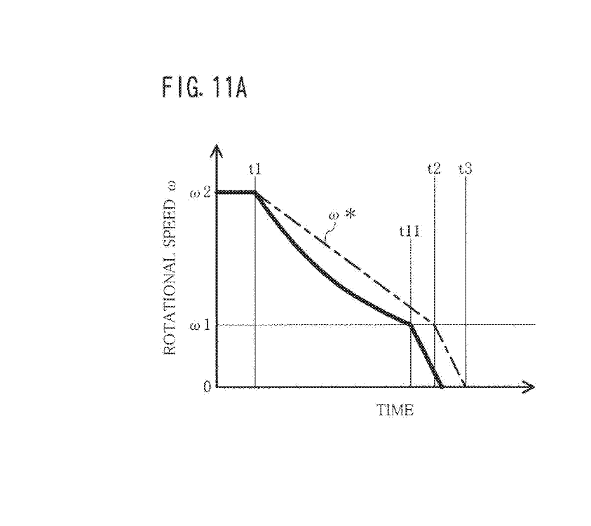

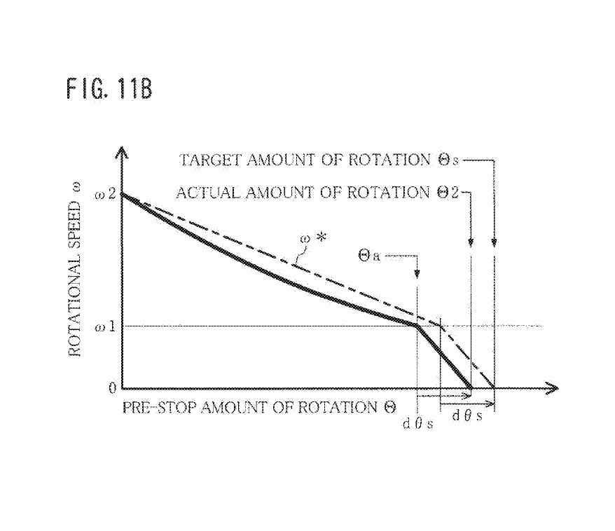

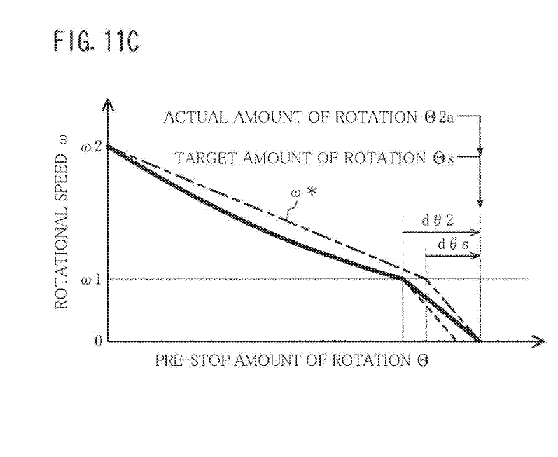

Refer n FIG. 11A, the rotational speed ω is reduced to the switch speed ω1 at a time t11 before the time t2. Further, the rotational speed ω is lower than the target speed ω* during a period from the time t1 the time t11.

For this reason, as shown in FIG. 11B, the pre-stop amount of rotation Θa at the time (t11) at which the rotational speed ω reaches the switch speed ω1 is smaller than the proper amount. Stated differently, as shown in FIG. 9C, the draw-in start position PS1 is farther from the target position PS2 than from the proper position.

In such a case, if the advance angle dθ is set at the reference advance angle dθs, an actual amount of rotation Θ2 becomes smaller than the target amount of rotation Θs. Stated differently, the rotor 32 stops before the target position PS2.

To cope with this, as clear from FIGS. 9C and 11C, the fixed excitation setting portion 29 sets, as the advance angle dθ, the advance angle dθ2 which is larger than the reference advance angle dθs so that the actual amount of rotation Θ2a becomes equal to the target amount of rotation Θs.

As discussed above, the set value of the advance angle dθ is so adjusted in accordance with the pre-stop amount of rotation Θa at a time when the rotational speed ω reaches the switch speed ω1. Thereby, even when is a difference between the rotational speed ω and the target speed ω* in the deceleration control, the rotor 32 can be stopped at the target position PS2.

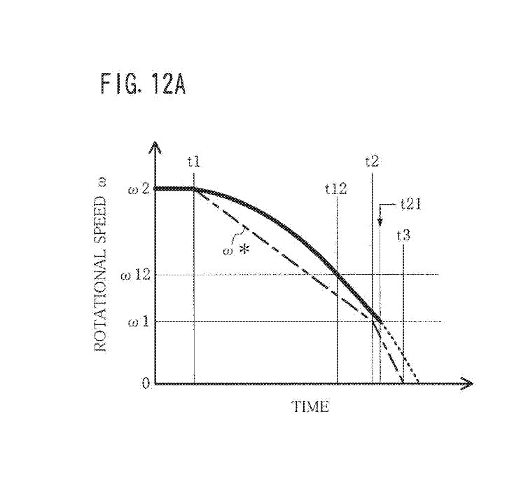

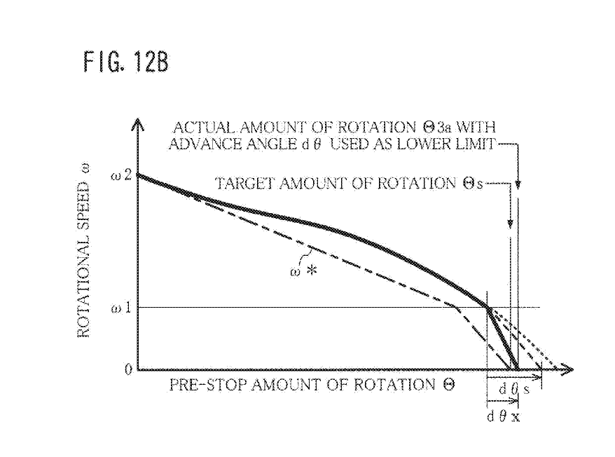

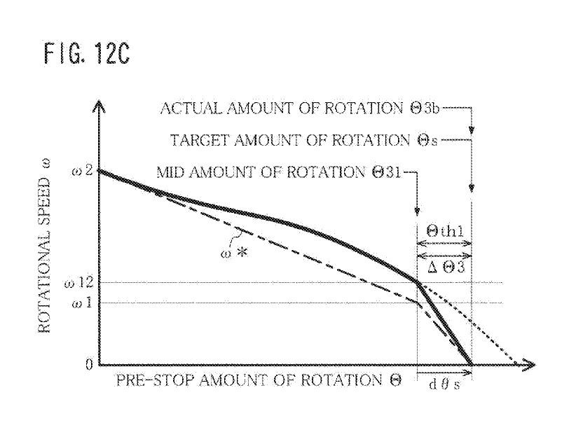

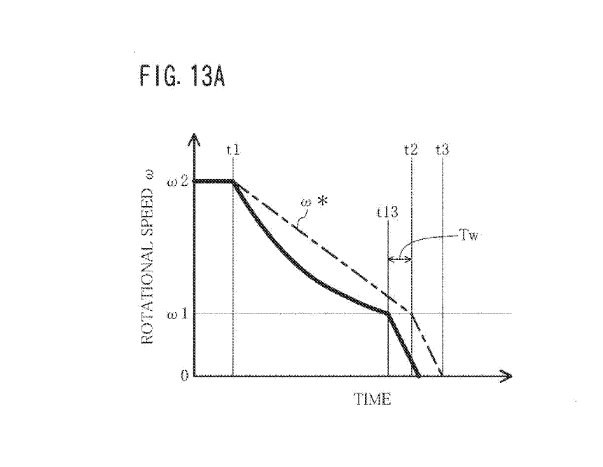

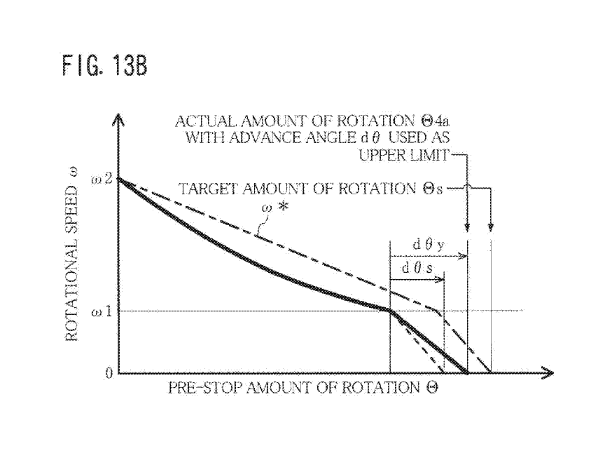

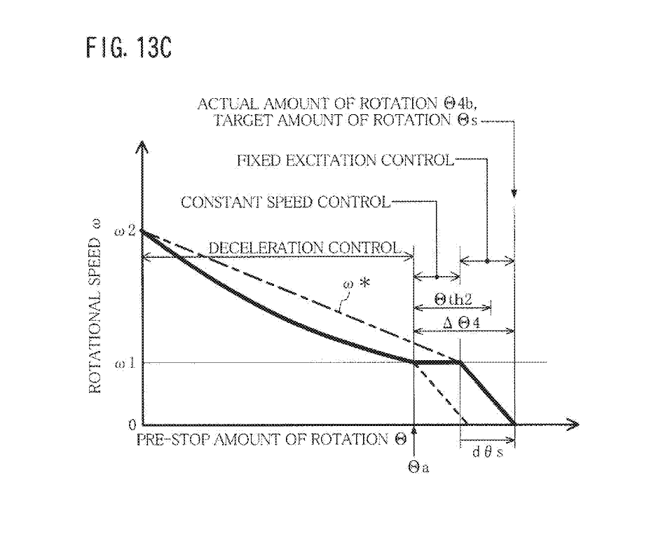

However, a case probably arises in which the rotor 32 cannot be stopped at the target position PS2 only by the adjustment of the advance angle dθ. For example, where the difference between the pre-stop amount of rotation Θa and the target position PS2 is excessively large, the rotor 32 cannot be stopped at the target position PS2 even if the advance angle dθ is increased or reduced to the limit of the variable range. Making the current vector 95 large increases the variable range of the advance angle dθ; however, it is impossible to pass a large current beyond the tolerance of the brushless motor 3. Thus, the increase in the variable range has a limitation. According to the examples of FIGS. 12A-13C, the rotor 32 can be stopped at the target position PS2 even when there is a shift of the amount of rotation which exceeds the limitation on the adjustment of the advance angle dθ.

Referring to FIG. 12A, a difference between the rotational speed ω and the target speed ω* in the deceleration control is larger than that in the case of FIG. 10A. In FIG. 12A, a time t21 at which the rotational speed ω is reduced to the switch speed ω1 comes after the proper time t2.

For this reason, if the advance angle dθ is set at an advance angle dθx which is the lower limit of the variable range as shown in FIG. 12B, an actual amount of rotation Θ3a becomes larger than the target amount of rotation Θs.

To cope with this, where the rotational speed ω (estimated speed ωm) is reduced to an early switch speed ω12 which is higher than the switch speed ω1 as shown in FIG. 12C, the fixed excitation setting portion 29 determines a difference ΔΘ3 between the target amount of rotation Θs and a mid amount of rotation Θ31 which is the pre-stop amount of rotation Θ of that time. If the difference ΔΘ3 thus determined is equal to or smaller than the threshold Θth1, then the fixed excitation setting portion 29 switches the control from the deceleration control to the fixed excitation control. For example, the fixed excitation setting portion 29 designates the advance angle dθ to the speed control unit 41, so that the control is switched.

If the difference ΔΘ3 thus determined is above the threshold Θth1, then the pre-stop amount of rotation Θ continues to be monitored until the rotational speed ω is reduced to the switch speed ω1.

The early switch speed ω12 and the threshold Θth1 may be selected, for example, based on the result of an experiment of measuring variation in difference of the rotational speed ω so that the rotor 32 can be stopped at the target position PS2 by setting the advance angle dθ within the variable range. In the example of FIG. 12C, the threshold Θth1 is set at the reference advance angle dθs.

Referring to FIG. 13A, a difference between the rotational speed ω and the target speed ω* in the deceleration control is larger than that in the case of FIG. 11A.

For this reason, if the advance angle dθ is set at an advance angle dθy which is the upper limit of the variable range as shown in FIG. 13B, an actual amount of rotation Θ4a becomes smaller than the target amount of rotation Θs.

To cope with this, where the pre-stop amount of rotation Θa at a time when the rotational speed ω (estimated speed ωm) is reduced to the switch speed ω1 is smaller than the target amount of rotation Θs as shown in FIG. 13C, the fixed excitation setting portion 29 determines a difference ΔΘ4 between the target amount of rotation Θs and the pre-stop amount of rotation Θa. If the difference ΔΘ4 thus determined is equal to or larger than the threshold Θth2, then the fixed excitation setting portion 29 informs the speed control unit 41 of the truth.

In response to the information, the speed control unit 41 performs, next to the deceleration control, a constant speed control in which the rotational speed ω is kept constant for a predetermined time Tw since the time t13.

In parallel with informing or after informing, the fixed excitation setting portion 29 sets the advance angle dθ so that the actual amount of rotation Θ4b becomes equal to the target amount of rotation Θs, and designates the advance angle dθ to the speed control unit 41 at the lapse of the time Tw. Thereby, the control is changed from the constant speed control to the fixed excitation control. In such a case, specifically, switching from the deceleration control to the fixed excitation control is made indirectly through the constant speed control.

If the difference ΔΘ4 determined is smaller than the threshold Θth2, next to the deceleration control, the fixed excitation control is performed without the constant speed control as with the example of FIG. 11.

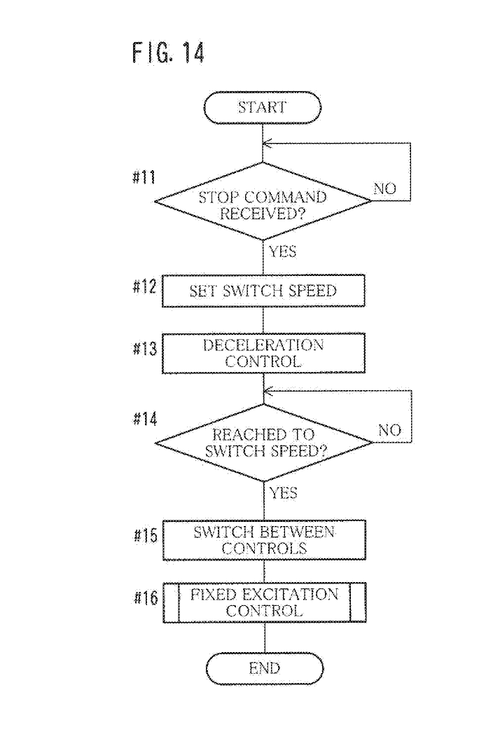

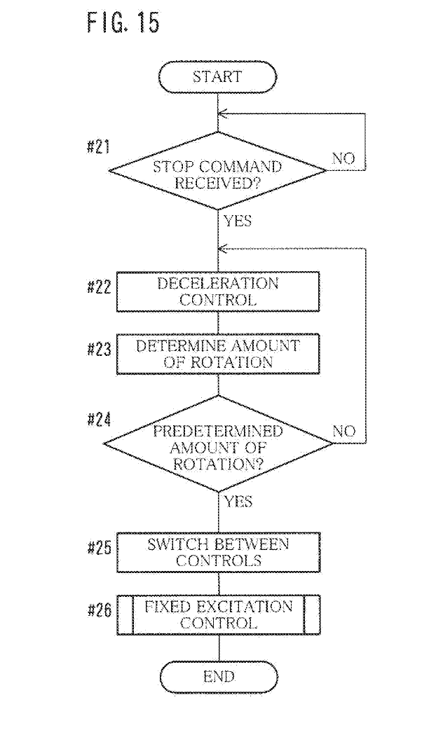

FIG. 14 shows a first example of the flow of processing by a motor controller. FIG. 15 shows a second example of the flow of processing by the motor controller.

Referring to FIG. 14, the motor controller 21 waits for the stop command S1e to be given from the upper control unit 20 (Step #11). If the stop command S1e is given (YES in Step #11), then the switch speed ω1 is set in a resistor for control use (Step #12), and then the deceleration control is started (Step #13).

If the estimated speed ωm obtained as the rotational speed ω is reduced to the switch speed ω1 (YES in Step #14), then the control is switched from the deceleration control to the fixed excitation control (Step #15). The fixed excitation control is performed to stop the rotation of the brushless motor 3 (Step #16).

Alternatively, the motor controller 21 performs the processing depicted in FIG. 15. To be specific, if the stop command S1e is given (YES in Step #21), then the deceleration control is started (Step #22). The motor controller 21 determines whether or not it is a time to start the fixed excitation control based on the pre-stop amount of rotation Θ (Step #23). If the motor controller 21 determines that it is not the time (NO in Step #24), then the deceleration control is continued. If the motor controller 21 determines that it is the time (YES in Step #24), then the control is switched from the deceleration control to the fixed excitation control (Step #25). Then, the fixed excitation control is performed to stop the rotation of the brushless motor 3 (Step #26).

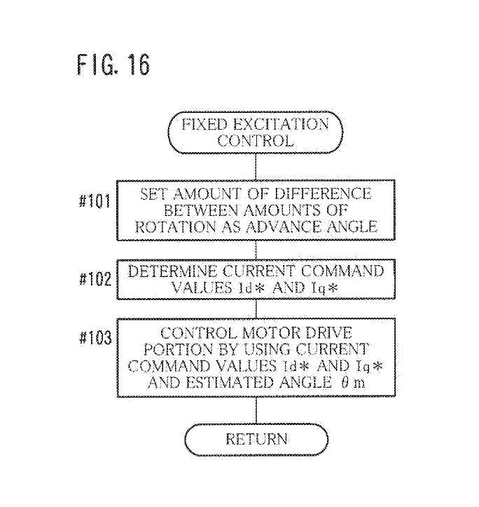

FIG. 16 shows an example of the flow of processing of the fixed excitation control. In the fixed excitation control, an amount of the difference between the pre-stop amount of rotation Θa and the target amount of rotation Θs is set as the advance angle dθ (Step #101). The d-axis component Id and the q-axis component of the current vector 95 is determined based on the advance angle dθ to determine the current command values Id* and Iq* (Step #102).

The current command values Id* and Iq* and the estimated angle θm are used to generate the control signals U+, U−, V+, V−, W+, and W−, and the control signals U+, U−, V+, V−, W+, and W− are given to the motor drive portion 26 (Step #103). In short, the motor drive portion 26 is so controlled as to supply the current corresponding to the magnetic field vector 85 to the brushless motor 3.

According to the foregoing embodiment, the rotor 32 of the brushless motor 3 can be stopped at the desired target position PS2. Where a difference is made between the rotational speed ω and the target speed ω* in the deceleration control, the rotor 32 can be stopped at the target position PS2.

In the foregoing embodiment, values of the currents of the U-phase, V-phase, and W-phase are set in an analog manner to generate a magnetic field for stopping the rotor 32. Thus, unlike a case of generating any of six patterns of magnetic fields determined based on combinations of ON, OFF, and direction of the currents of all the phases, the target position PS2 can be set variably.

In the forgoing embodiment, the magnitude of the current vector 95 is increased or decreased depending on the advance angle dθ, so that the rotor 32 can stop in a gentle manner so that little vibration occurs immediately before the rotor 32 stops. The reduction in vibration leads to reduction in wait time for the vibration to disappear, which causes the rotor 32 to stop early.

The current in the fixed excitation control is preferably passed before the lapse of a time which is obtained by adding an expected time before the stop of the rotor 32 and an extra time. Alternatively, the current in the fixed excitation control may be passed until the next start command is inputted. In such a case, the position of magnetic pole PS is known because the position of the rotor 32 is fixed as-is. Thus, the processing for estimating the position of magnetic pole PS at the next start-up may be omitted.

In the foregoing embodiment, for the fixed excitation control, the estimated angle θm is inputted as a control value for designating the direction of the magnetic field vector 85 to the coordinate transformation portion 28 and the voltage pattern generating portion 43. Instead of this, however, an angle obtained by adding the advance angle dθ set and the estimated angle θm may be inputted. In such a case, the current command value Id* may be a value indicating the magnitude of the current vector 95 and the current command value Iq* may be set at 0 (zero).

It is to be understood that the configuration of the image forming apparatus 1 and the motor controller 21, the constituent elements thereof, the content of the processing, the order of the processing, the time of the processing, the structure of the brushless motor 3, and the like may be appropriately modified without departing from the spirit of the present invention.

Although embodiments of the present invention have been described and illustrated in detail, the disclosed embodiments are made for purposes of illustration and example only and not limitation. The scope of the present invention should be interpreted by terms of the appended claims.

What is claimed is:

1. A controller for a permanent magnet synchronous motor having a rotor using a permanent magnet, the rotor rotating by a rotating magnetic field caused by a current flowing through an armature, the controller comprising:
a drive portion configured to pass current through the armature to drive the rotor;
a speed estimating portion configured to estimate a rotational speed of the rotor based on the current flowing through the armature;
a control unit configured to control the drive portion to cause the rotating magnetic field based on an estimated speed that is the rotational speed estimated by the speed estimating portion, to perform, in response to a stop command inputted, a deceleration control of reducing the rotational speed to a switch speed on the drive portion, and then, to perform a fixed excitation control of causing a magnetic field vector for stopping the rotor at a target position on the drive portion;
an amount of rotation calculation portion configured to calculate a pre-stop amount of rotation that is an amount of rotation of the rotor since the deceleration control has started; and
a fixed excitation setting portion configured to set, in accordance with the pre-stop amount of rotation, the current to be passed through the armature to generate the magnetic field vector.

2. The controller for the permanent magnet synchronous motor according to claim 1, wherein
where the pre-stop amount of rotation is larger than a target amount of rotation which is an amount of rotation of the rotor between the start of the deceleration control and the stop at the target position, the fixed excitation setting portion sets an advance angle to be smaller than a reference advance angle corresponding to the target amount of rotation, the advance angle being a control value that designates a phase of the current, and
where the pre-stop amount of rotation is smaller than the target amount of rotation, the fixed excitation setting portion sets the advance angle to be larger than the reference advance angle.

3. The controller for the permanent magnet synchronous motor according to claim 1, wherein the control unit switches the control from the deceleration control to the fixed excitation control directly or indirectly where a difference between the pre-stop amount of rotation and the target amount of rotation at a time when the estimated speed is reduced to an early switch speed higher than the switch speed is equal to or smaller than a threshold.

4. The controller for the permanent magnet synchronous motor according to claim 1, wherein the control unit performs, next to the deceleration control, a constant speed control of keeping the rotational speed constant for a predetermined period of time where the pre-stop amount of rotation is smaller than the target amount of rotation and a difference between the pre-stop amount of rotation and the target amount of rotation is equal to or larger than a threshold at a time when the estimated speed is reduced to the switch speed, and then, the control unit switches the control from the constant speed control to the fixed excitation control.

5. The controller for the permanent magnet synchronous motor according to claim 4, wherein the predetermined period of time is a time taken for the pre-stop amount of rotation to reach the target amount of rotation.

6. An image forming apparatus for forming an image onto paper, the image forming apparatus comprising:
a permanent magnet synchronous motor having a rotor using a permanent magnet, the rotor rotating by a rotating magnetic field caused by a current flowing through an armature;
a roller of which rotation is driven by the permanent magnet synchronous motor to convey the paper;
a controller configured to control the permanent magnet synchronous motor; and
a stop command portion configured to input a stop command to the controller; wherein
the controller includes
a drive portion configured to pass a current through the armature to drive the rotor,
a speed estimating portion configured to estimate a rotational speed of the rotor based on the current flowing through the armature,
a control unit configured to control the drive portion to cause the rotating magnetic field based on the rotational speed estimated by the speed estimating portion, to perform, in response to a stop command inputted, a deceleration control of reducing the rotational speed to a switch speed on the drive portion, and then, to perform a fixed excitation control of causing a magnetic field vector for stopping the rotor at a target position on the drive portion,
an amount of rotation calculation portion configured to calculate a pre-stop amount of rotation that is an amount of rotation of the rotor since the deceleration control has started, and
a fixed excitation setting portion configured to set, in accordance with the pre-stop amount of rotation, the current to be passed through the armature to generate the magnetic field vector.

7. A method for controlling a permanent magnet synchronous motor having a rotor using a permanent magnet, the rotor rotating by a rotating magnetic field caused by a current flowing through an armature, the method comprising:
starting a deceleration control of reducing a rotational speed of the rotor when a stop command is inputted in a state where the rotor rotates at a predetermined rotational speed; and
performing a fixed excitation control when the rotational speed is reduced to a set speed, the fixed excitation control including setting a current for causing a magnetic field vector for stopping the rotor at a target position in accordance with an amount of rotation of the rotor since the deceleration control has started and passing the current through the armature.
